(19) United States
(12) Patent Application Publication
(10) Pub. No.: US 2024/0096198 A1
(43) Pub. Date: Mar. 21, 2024

(54) AREA DETERMINATION APPARATUS, CONTROL METHOD, COMPUTER READABLE MEDIUM, MONITORING SYSTEM, MONITORING METHOD

(71) Applicant: NEC Corporation, Minato-ku, Tokyo (JP)

(72) Inventors: Akira Tsuji, Tokyo (JP); Shigeo Suzuki, Tokyo (JP); Hiroshi Matsumoto, Tokyo (JP); Takanori Shigeta, Tokyo (JP)

(73) Assignee: NEC Corporation, Minato-ku, Tokyo (JP)

(21) Appl. No.: 18/274,633

(22) PCT Filed: Jan. 29, 2021
(86) PCT No.: PCT/JP2021/003296

§ 371 Date: Jul. 27, 2023

(51) Int. Cl. G08B 25/00

(52) U.S. Cl. CPC G08B 25/008

(57) ABSTRACT

An area determination apparatus (2000) acquires three-dimensional facility data (20). The three-dimensional facility data (20) is three-dimensional data of a target facility including a plurality of segments. The area determination apparatus (2000) determines a designated segment, which is a segment designated in an input screen (10) including an image of the target facility. The area determination apparatus (2000) determines, as a monitoring area or a non-monitoring area, a three-dimensional area that is determined based on three-dimensional segment data (22) of the designated segment.

### TECHNICAL FIELD

The present disclosure relates to a technique for determining an area to be monitored.

### BACKGROUND ART

Systems for monitoring the behavior of people or the like have been developed. For example, Patent Literature 1 discloses a system for monitoring a monitoring area by using monitoring cameras. In this system, the monitoring area is set by using a map in which stores to be monitored and the like are shown in a plan view.

### CITATION LIST

### Patent Literature

Patent Literature 1: Japanese Unexamined Patent Application Publication No. 2020-178149

### SUMMARY OF INVENTION

### Technical Problem

In the system disclosed by Patent Literature 1, 2D (two-dimensional) areas are set as monitoring area. The present invention has been made in view of the above-described problem, and an object thereof is to provide a technique for making it possible to flexibly set an area to be monitored.

### Solution to Problem

An area determination apparatus according to the present disclosure include: an acquiring unit configured to acquire three-dimensional facility data, which is three-dimensional data of a target facility including a plurality of segments; a segment determining unit configured to determine a designated segment, which is a segment designated in an input screen including an image of the target facility; and an area determining unit configured to determine, as a monitoring area or a non-monitoring area, a three-dimensional area that is determined based on three-dimensional data of the designated segment.

A control method according to the present disclosure is performed by a computer. The control method includes: an acquisition step of acquiring three-dimensional facility data, which is three-dimensional data of a target facility including a plurality of segments; a segment determining step of determining a designated segment, which is a segment designated in an input screen including an image of the target facility; and an area determination step of determining, as a monitoring area or a non-monitoring area, a three-dimensional area that is determined based on three-dimensional data of the designated segment.

A computer readable medium according to the present disclosure stores a program for causing a computer to perform a control method according to the present disclosure.

A monitoring system according to the present disclosure includes an area determination apparatus and a monitoring apparatus.

The area determination apparatus includes: an acquiring unit configured to acquire three-dimensional facility data, which is three-dimensional data of a target facility including a plurality of segments; a segment determining unit configured to determine a designated segment, which is the segment designated in an input screen including an image of the target facility; an area determining unit configured to determine, as a monitoring area or a non-monitoring area, a three-dimensional area that is determined based on three-dimensional data of the designated segment; and an output unit configured to output area information indicating the monitoring area or the non-monitoring area.

The monitoring apparatus includes: an acquiring unit configured to acquire the area information and position information indicating a position of a monitoring target object; a determining unit configured to determine whether or not a positional relationship between the position of the monitoring target object and the monitoring area that is determined based on the area information satisfies a predetermined condition; and an outputting unit configured to output output information based on a result of the determination.

A monitoring method according to the present disclosure is performed by a monitoring system including an area determination apparatus and a monitoring apparatus.

The area determination apparatus performs: an acquisition step of acquiring three-dimensional facility data, which is three-dimensional data of a target facility including a plurality of segments; a segment determining step of determining a designated segment, which is the segment designated in an input screen including an image of the target facility; an area determination step of determining, as a monitoring area or a non-monitoring area, a three-dimensional area that is determined based on three-dimensional data of the designated segment; and an output step of outputting area information indicating the monitoring area or the non-monitoring area.

The monitoring apparatus performs: an acquisition step of acquiring the area information and position information indicating a position of a monitoring target object; a determination step of determining whether or not a positional relationship between the position of the monitoring target object and the monitoring area that is determined based on the area information satisfies a predetermined condition; and an output step of outputting output information based on a result of the determination.

### Advantageous Effects of Invention

According to the present disclosure, a technique for making it possible to flexibly set an area to be monitored is provided.

### BRIEF DESCRIPTION OF DRAWINGS

FIG. 1 shows an example of an outline of operations performed by an area determination apparatus according to a first example embodiment;

FIG. 2 is a block diagram showing an example of a functional configuration of the area determination apparatus according to the first example embodiment;

FIG. 3 is a block diagram showing an example of a hardware configuration of a computer that implements an area determination apparatus;

FIG. 4 is a flowchart showing an example of a flow of processes performed by the area determination apparatus according to the first example embodiment;

FIG. 5 shows an example of an input screen;

FIG. 6A is a first diagram showing an example of a method for specifying a designated segment based on a designated area;

FIG. 6B is the first diagram showing an example of a method for specifying a designated segment based on a designated area;

FIG. 6C is the first diagram showing an example of a method for specifying a designated segment based on a designated area;

FIG. 7A is a second diagram showing an example of a method for specifying a designated segment based on a designated area;

FIG. 7B is the second diagram showing an example of a method for specifying a designated segment based on a designated area;

FIG. 7C is the second diagram showing an example of a method for specifying a designated segment based on a designated area;

FIG. 8 shows an example of a monitoring system;

FIG. 9 shows an example of a functional configuration of the monitoring apparatus; and

FIG. 10 is a flowchart showing an example of a flow of processes performed by a monitoring apparatus 3000.

### EXAMPLE EMBODIMENT

An example embodiment according to the present disclosure will be described hereinafter in detail with reference to the drawings. Further, components corresponding to or the same as each other are assigned the same or corresponding numerical numbers (or symbols) throughout the drawings, and redundant descriptions thereof are omitted as appropriate. Further, unless otherwise described, pre-defined values such as predetermined values and thresholds are stored in advance in a storage device or the like accessible from an apparatus that uses these values.

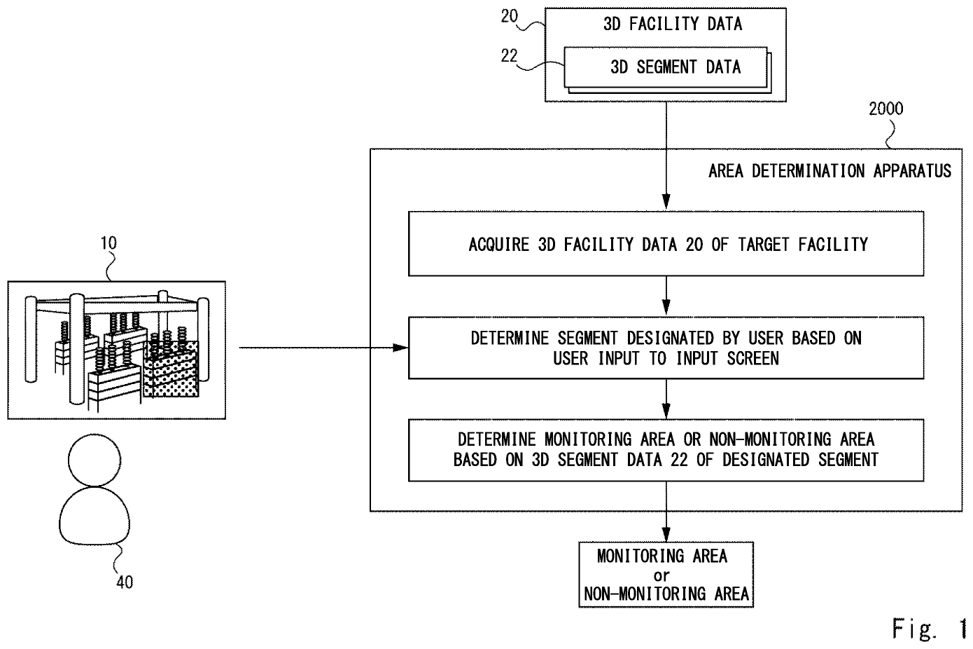

FIG. 1 shows an example of an overview of operations performed by an area determination apparatus 2000 according to a first example embodiment. Note that FIG. 1 is a diagram for facilitating the understanding of the overview of operations performed by the area determination apparatus 2000, and operations performed by the area determination apparatus 2000 are not limited to those shown in FIG. 1.

The area determination apparatus 2000 determines a 3D (three-dimensional) monitoring area (i.e., a 3D area to be monitored) or a 3D non-monitoring area (i.e., a 3D area not to be monitored) that is designated in a specific 3D space by using 3D data of a target facility (3D facility data 20). Hereinafter, the aforementioned specific 3D space is also referred to as a “specific space”. The target facility is an arbitrary facility including at least one piece of equipment. For example, the target facility is a power plant, a steel plant, or a chemical plant. Further, the target facility may also include components (wiring lines or pipes) that connect between pieces of equipment, and passages between pieces of equipment. Further, the target facility may also include spaces around equipment. For example, a substation, which is a type of power plant, includes equipment such as transformers, disconnectors, and circuit breakers. Further, adjacent pieces of equipment are connected to each other by lead wires. Further, the lead wires are supported by steel towers or the like in which the lead wires are grounded through insulators. As described above, the substation includes transformers, disconnectors, circuit breakers, lead wires, insulators, steel towers, and so on, and also includes spaces around these pieces of equipment.

The specific space is a virtual 3D space corresponding to a target facility and a 3D space therearound in the real world. The monitoring area is a 3D area in the specific space and represents a 3D area to be monitored in the real world. The non-monitoring area is a 3D area in the specific space, and represents a 3D area not to be monitored in the real world. In other words, the monitoring area is an area in the specific space onto which a 3D area to be monitored in the real world is mapped. In contrast, the non-monitoring area is an area in the specific space onto which a 3D area not to be monitored in the real world is mapped. Hereafter, monitoring areas and non-monitoring areas are also collectively referred to as designated areas.

For example, in the case of a power plant, it is dangerous to approach a high-voltage equipment. Therefore, if it is possible to monitor the high-voltage equipment and the like so as to prevent people from entering the vicinity thereof, the safety of the operation of the power plant can be improved. Accordingly, for example, the area determination apparatus 2000 is used to enable a user 40 to determine a monitoring area based on his/her designation, and monitor a 3D area in the real world corresponding to this monitoring area. Note that, in the case where a non-monitoring area is designated by the user 40, it is possible to determine the monitoring area by, for example, handling an area that is the specific space from which the non-monitoring area is excluded as the monitoring area. For example, in the case of a power plant, it is conceivable that the user 40 performs monitoring by designating, as the non-monitoring area, an area that is safe for people to enter, and handling the area other than the non-monitoring area as the monitoring area that people should not enter.

Here, it is assumed that a target facility includes a plurality of segments. For example, when the target facility is divided into meaningful constitutional units (i.e., meaningful components), each segment corresponds to one of the components. For example, each equipment or a group of equipment that constitutes the target facility is handled as one segment. Alternatively, for example, each of components or groups of components constituting a piece of equipment is handled as one segment. For example, in the case of the aforementioned substation, each of transformers, disconnectors, circuit breakers, lead wires, insulators, steel towers, and the like is handled as a segment.

The area determination apparatus 2000 acquires 3D facility data 20 for the target facility. The 3D facility data 20 of the target facility is 3D data representing the position and shape of the target facility in the specific space. In other words, the 3D facility data 20 represents what is obtained by mapping the target facility in the real world onto the specific space. The 3D facility data 20 contains 3D data (3D segment data 22) for each of the segments constituting the target facility. The 3D segment data 22 of a segment is 3D data representing the position and shape of that segment in the specific space.

The user 40 specifies at least one segment by using an input screen 10 on which 3D facility data 20 is displayed. Hereafter, a segment designated by the user 40 is referred to as a designated segment. The area determination apparatus 2000 determines a designated segment based on an input by the user to the input screen 10. Then, the area determination apparatus 2000 determines a designated area based on 3D segment data 22 of the designated segment (hereinafter also referred to as designated segment data). The designated area is a 3D area in the specific space that is determined based on the designated segment data.

The designated area may be the 3D area represented by the designated segment data as it is or other types of 3D area determined based on the designated segment data. In the latter case, for example, it is possible to handle a 3D area that is obtained by adding a margin having a specific size to the designated segment data as a monitoring area. In this way, it is possible to, for example, set a monitoring area that represents a meaning that “Do not enter a space within a predetermined distance from the segment designated by the user 40”.

### <Example of Advantageous Effect>

According to the area determination apparatus 2000 in accordance with this example embodiment, based on an input by the user 40 to the input screen 10 that is generated using the 3D facility data of the target facility, the segment of the target facility that is specified by the user 40 is determined. Then, a 3D area that is determined based on 3D segment data 22 representing the designated segment is determined as a monitoring area or a non-monitoring area. According to this way, it is possible to determine a 3D area as the monitoring area unlike the case where a monitoring area is set by using a map in which a place to be monitored is shown in a plan view. In other words, it is possible to set a monitoring area taking into consideration not only a position on the horizontal plane but also a position in the vertical direction. In this way, it is possible to set a monitoring area more flexibly than the case where a monitoring area can be set only as a 2D (two-dimensional) area.

Suppose that a power plant including a steel tower is monitored. In some cases, a steel tower of a power plant has dangerous equipment in a high area thereof, and it is desired to monitor this dangerous equipment (e.g., it is desired to give a warning when approaching the dangerous equipment). However, in the case of a map in which the power plant is shown in a plan view, although it is possible to set the whole steel tower as a monitoring area, it is impossible to set only the dangerous equipment disposed in a high area of the steel tower or only the area therearound as a monitoring area. Therefore, for example, if a system that issues a warning when a person or the like enters a monitoring area is provided, a warning is issued when a person or the like merely approaches a steel tower. That is, it is impossible to operate the system so that a warning is issued only when a person or the like approaches the dangerous equipment disposed in a high area.

In this regard, according to the area determination apparatus 2000 in accordance with this example embodiment, it is possible to set a 3D area corresponding to a dangerous equipment disposed in a high area or an area therearound as a monitoring area by using the above-described 3D facility data 20 of the power plant and designating a segment corresponding to the dangerous equipment. Therefore, for example, when a system that issues a warning when a person or the like enters a monitoring area is provided, a warning is not issued when a person or the like merely approaches a steel tower. That is, it is possible to operate the system so that a warning is issued only when a person or the like approaches the dangerous equipment disposed in a high area.

Further, in the area determination apparatus 2000 according to this example embodiment, the 3D facility data 20 of the target facility contains 3D segment data 22 of each segment, so that it is possible to designate a monitoring area or a non-monitoring area by designating a segment. Therefore, it is possible to easily designate a monitoring area or a non-monitoring area.

The area determination apparatus 2000 according to this example embodiment will be described hereinafter in a more detailed manner.

### <Example of Functional Configuration>

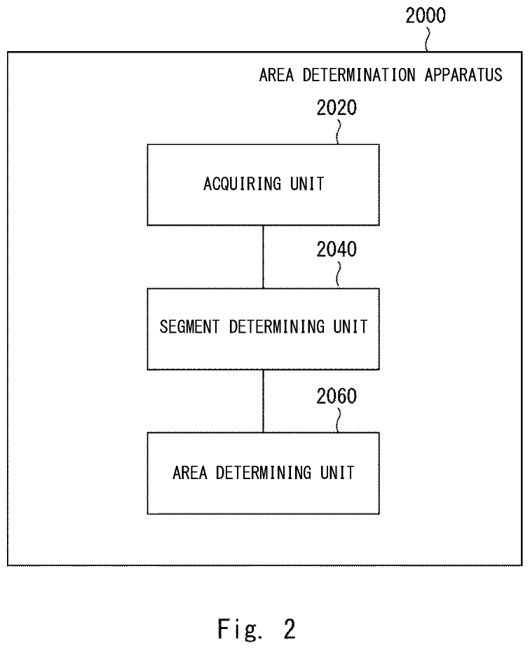

FIG. 2 is a block diagram showing an example of a functional configuration of the area determination apparatus 2000 according to the first example embodiment. The area determination apparatus 2000 includes an acquiring unit 2020, a segment determining unit 2040, and an area determining unit 2060. The acquiring unit 2020 acquires 3D facility data 20. The segment determining unit 2040 determines a designated segment based on an input by the user to the input screen 10. The area determining unit 2060 determines a designated area based on 3D segment data 22 of the designated segment.

### <Example of Hardware Configuration>

Each of functional components of the area determination apparatus 2000 may be implemented either by hardware for implementing that functional component (e.g., a hardwired electronic circuit or the like) or by a combination of hardware and software (e.g., a combination of an electronic circuit and a program for controlling the electronic circuit or the like). A case where each of functional components of the area determination apparatus 2000 is implemented by a combination of hardware and software will be further described hereinafter.

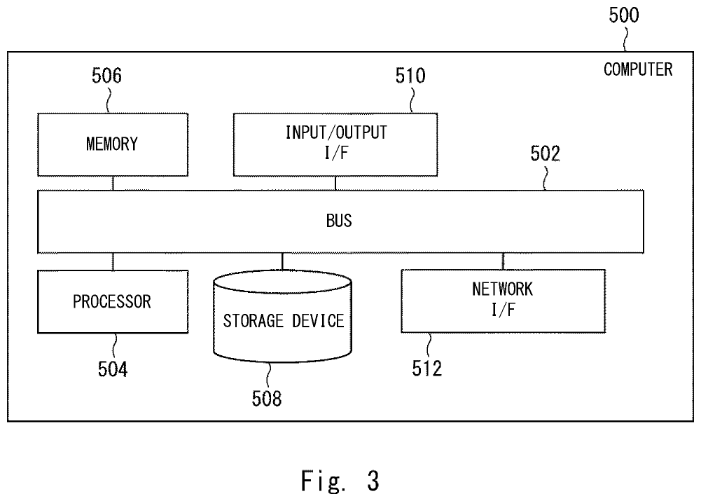

FIG. 3 is a block diagram showing an example of a hardware configuration of a computer 500 that implements the area determination apparatus 2000. The computer 500 is an arbitrary computer. For example, the computer 500 is a stationary computer such as a PC (Personal Computer) or a server machine. Alternatively, the computer 500 is, for example, a portable computer such as a smartphone or a tablet-type terminal. The computer 500 may be a special-purpose computer designed to implement the area determination apparatus 2000, or may be a general-purpose computer.

For example, each of functions of the area determination apparatus 2000 is implemented by the computer 500 by installing a predetermined application in the computer 500. The above-described application is composed of a program for implementing the functional component of the area determination apparatus 2000. Note that how to acquire the above-described program is arbitrarily determined. For example, the program can be acquired from a storage medium (such as a DVD or a USB memory) in which the program is stored. Alternatively, the program can be acquired, for example, by downloading the program from a server apparatus that manages a storage device in which the program is stored.

The computer 500 includes a bus 502, a processor 504, a memory 506, a storage device 508, an input/output interface 510, and a network interface 512. The bus 502 is a data transmission path through which the processor 504, the memory 506, the storage device 508, the input/output interface 510, and the network interface 512 transmit and receive data to and from each other. However, the method for connecting the processor 504 and the like to each other is not limited to connections through buses.

The processor 504 is any of various types of processors such as a CPU (Central Processing Unit), a GPU (Graphics Processing Unit), or an FPGA (Field-Programmable Gate Array). The memory 506 is a primary storage device implemented by using a RAM (Random Access Memory) or the like. The storage device 508 is a secondary storage device implemented by using a hard disk drive, an SSD (Solid State Drive), a memory card, or a ROM (Read Only Memory).

The input/output interface 510 is an interface for connecting the computer 500 with an input/output device(s). For example, an input device such as a keyboard and an output device such as a display device are connected to the input/output interface 510.

The network interface 512 is an interface for connecting the computer 500 to a network. The network may be a LAN (Local Area Network) or a WAN (Wide Area Network).

In the storage device 508, programs for implementing respective functional components of the area determination apparatus 2000 (programs for implementing the above-described applications) are stored. The processor 504 implements each of functional components of the area determination apparatus 2000 by loading the aforementioned program onto the memory 506 and executing the loaded program.

The area determination apparatus 2000 may be implemented by one computer 500 or by a plurality of computers 500. In the latter case, the configurations of the computers 500 do not need to be identical to each other, but can be different from each other.

The area determination apparatus 2000 may be a computer that is directly operated by the user 40 (hereinafter also referred to as a user terminal), or may be a server machine or the like that is connected to user terminals so that they can communicate with each other. The user terminal may be, for example, a mobile terminal or a PC possessed (or carried) by the user 40.

In the case where the area determination apparatus 2000 is a server machine or the like, the area determination apparatus 2000 provides an input screen 10 (e.g., an input window 10) to a user terminal, so that the input screen 10 is displayed on a display device of the user terminal. Further, the area determination apparatus 2000 acquires information representing the contents of an input by the user to the input screen 10 from the user terminal. Note that “the display device of the user terminal” is a display device on which information output from the user terminal is displayed, such as a display device provided in a mobile terminal or a display device connected to a PC.

### <Flow of Processes>

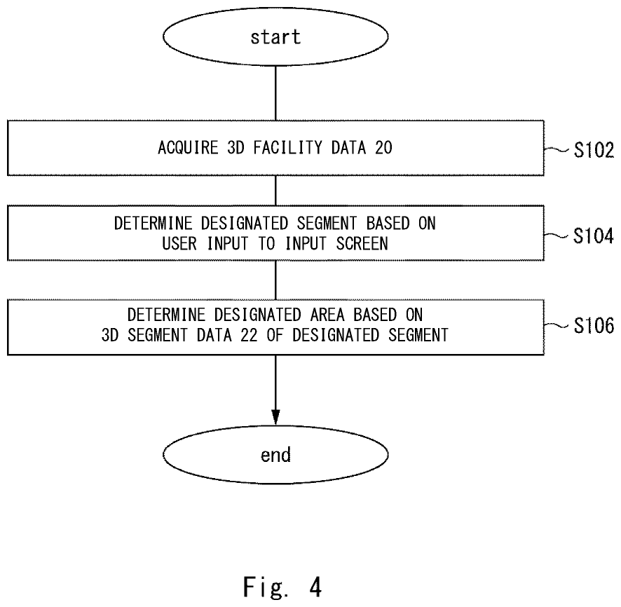

FIG. 4 is a flowchart showing an example of a flow of processes performed by the area determination apparatus 2000 according to the first example embodiment. The acquiring unit 2020 acquires 3D facility data 20 (S102). The segment determining unit 2040 determines a designated segment based on an input by the user to the input screen (S104). The area determining unit 2060 determines a designated area based on 3D segment data 22 of the designated segment (S106).

### <Acquisition of 3D Facility Data 20: S102>

The acquiring unit 2020 acquires 3D facility data 20 of the target facility (S102). Note that when the area determination apparatus 2000 can handle a plurality of facilities as target facilities (i.e., when the area determination apparatus 2000 can select one of facilities), the acquiring unit 2020 determines a facility to be handled as a target facility, and acquires 3D facility data 20 of the determined facility. In this case, for example, identification information of each target facility is stored in a storage device in advance in association with the 3D facility data that represents a 3D data of that target facility in the specific space, wherein the storage device accessible from the area determination apparatus 2000. The acquiring unit 2020 acquires the identification information of the target facility, and acquires the 3D facility data 20 that is stored, in the storage device, in association with the acquired identification information.

There are various methods by which the acquiring unit 2020 determines a facility to be handled as a target facility. For example, the area determination apparatus 2000 determines a facility to be handled as a target facility according to the input by the user 40. In this case, for example, the acquiring unit 2020 provides, to the user 40, a screen (e.g., a window) on which he/she can designate a facility. This screen is displayed on a display device of a computer (hereinafter also referred to as an operation terminal) that the user 40 can operate. For example, the operation terminal may be a mobile terminal such as a tablet-type terminal or a smartphone, or a stationary computer such as a PC. The user 40 designates a facility to be handled as a target facility by using the screen displayed on the operation terminal. The area determination apparatus 2000 acquires 3D facility data 20 corresponding to the identification information of the facility designated by the user 40 as 3D facility data 20 of the target facility.

### <<Method for Generating 3D Facility Data 20>>

The 3D facility data 20 represents 3D data of a target facility in the specific space. More specifically, the 3D facility data 20 represents the position and shape of the target facility in the specific space by a plurality of coordinate data on a 3D coordinate system in which the specific space is defined.

For example, the 3D facility data 20 is represented by point cloud data that is obtained by scanning the target facility in a three-dimensional manner. Such 3D scanning of an object can be carried out by using LiDAR (light detection and ranging) or the like. Note that an existing technique can be used as a technique for generating 3D data of a facility or the like present in the real world in a virtual 3D space by scanning the facility in a three-dimensional manner.

Note that the 3D facility data 20 is not limited to point cloud data, but can be any kind of data that can represent the shape and position of a 3D object existing in a specific 3D space. For example, a polygon data that is obtained from the above-described point cloud data obtained by the 3D scanning or a surface data that is obtained from such polygon data can be used as 3D facility data 20.

The method for generating 3D facility data 20 is not limited to the 3D scanning of an object. For example, the 3D facility data 20 may be manually generated by using 3D modeling software. In this case, for example, an operator generates 3D data of each equipment that constitutes a target facility on the modeling software by using a blueprint of that equipment. Further, the operator disposes the generated 3D data of each equipment in such a manner that the arrangement of the 3D data of each equipment in the 3D space on the modeling software is identical to the arrangement of each equipment in the real world.

Note that the 3D facility data 20 contains 3D segment data 22 for each segment. For example, the 3D facility data 20 of a given facility contains, for each of segments included in that facility, a pair of “identification information of that segment and its 3D segment data 22”. To generate such 3D facility data 20, it is necessary to generate 3D segment data 22 for each of segments included in the facility.

Various existing techniques can be used as a technique for generating a 3D data for each component regarding an object that is constituted by a plurality of components mentioned above. For example, in the case where point cloud data is obtained by scanning a facility in a three-dimensional manner, the point cloud data can be divided into a plurality of point cloud data for respective segments by performing certain processing such as semantic segmentation on the point cloud data. Further, it is possible to obtain, for each of the segments, polygon data or surface data of that segment by converting a respective one of the plurality of point cloud data, which have been obtained by dividing the original point could data into the plurality of point cloud data, into the polygon data or the surface data.

Further, in the case where 3D facility data 20 is manually generated by using 3D modeling software or the like, it is possible to generate 3D facility data 20 containing 3D segment data 22 of each segment by, for example, generating the 3D segment data 22 of each segment by the above-described software.

### <Determination of Designated Segment: S104>

The segment determining unit 2040 determines a designated segment based on an input by the user to the input screen 10 (S104). To do so, the area determination apparatus 2000 provides an input screen 10 (e.g., an input window 10) to the user 40 and acquires information representing the contents of an input by the user to the input screen 10. The segment determining unit 2040 determines a designated segment based on the contents of the input by the user. The input screen 10 is displayed on the display device of the user terminal.

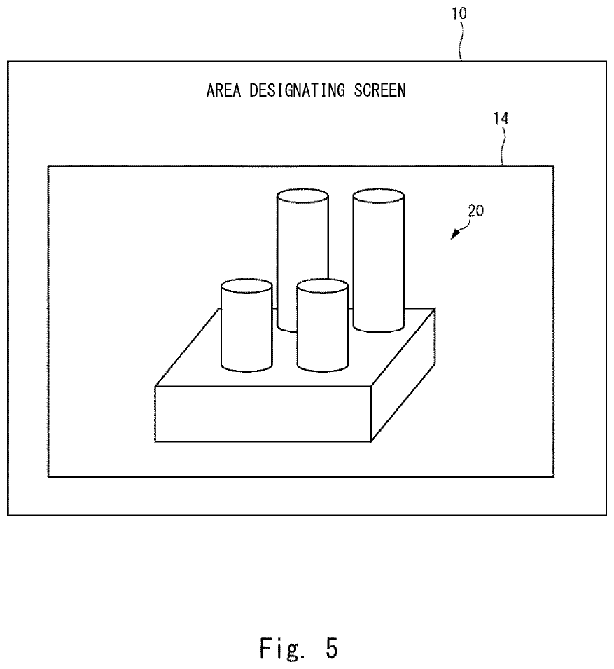

FIG. 5 shows an example of the input screen 10. The input screen 10 has a display area 14. The 3D facility data 20 is displayed on the display area 14. Specifically, a projection of 3D facility data is displayed on the display area 14. It should be noted that the user can change the projection so that a desired part of the 3D facility data 20 is displayed on the display area 14. Note that a technique used for viewers of 3D modeling software or the like can be used as the technique for changing the contents displayed on the screen on which an arbitrary part of 3D data of an object is displayed.

For example, a projection of 3D facility data 20 can be handled as a captured image obtained by capturing the 3D facility data 20 by a virtual camera disposed in the specific space (hereinafter also referred to simply as a virtual camera). In this way, the contents displayed in the display area 14 are determined by the position, the orientation, and the angle of view of the virtual camera in the specific space. Therefore, it is possible to display, for example, various parts of the target facility on the display area 14 by changing the position, the orientation, and the angle of view of the virtual camera according to a drag operation or a pinch operation performed by the user 40. Hereafter, the position, the orientation, and the angle of view of the virtual camera are collectively referred to as parameters of the virtual camera.

For example, the user 40 designates a segment by designating a point(s) or an area in the display area 14. Hereafter, the point and the area designated by the user 40 are called a designated point and a designated area, respectively. Suppose that, the user 40 has designated a designated point in the display area 14. In this case, the segment determining unit 2040 determines, as a designated segment, a segment that overlaps the designated point in the projection of the 3D facility data 20 displayed in the display area 14 when the designated point is designated. Note that an existing technique can be used as the technique for, when a certain point on the screen on which a plurality of 3D data (a plurality of 3D segment data 22, in this example) are displayed is designated, determining 3D data designated by that point.

Alternatively, suppose that the user 40 has designated a designated area in the display area 14. In this case, for example, the segment determining unit 2040 determines, as a designated segment, a segment that overlaps a 3D area that is obtained by extending the designated area in the depth direction (hereinafter also referred to as an extended area).

Note that the segment determining unit 2040 may handle a segment at least a part of which overlaps the extended area as the designated segment, or may handle only a segment which entirely overlaps (i.e., is entirely contained in) the extended area as the designated segment.

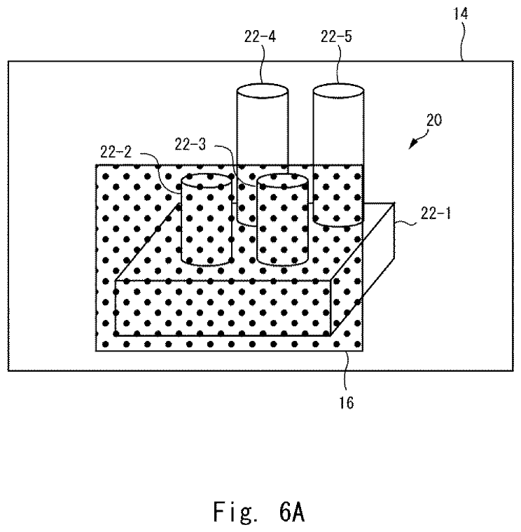

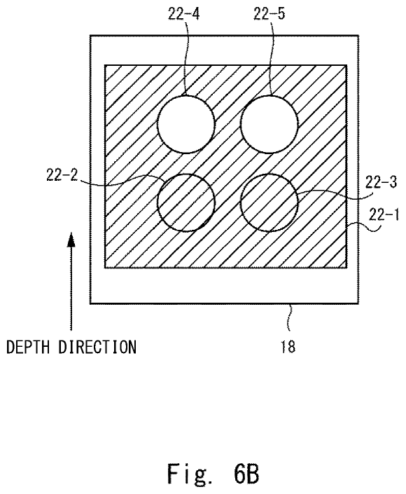

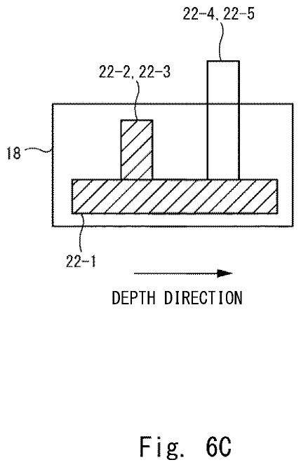

FIGS. 6A to 6C are first diagrams showing an example of a method for determining a designated segment based on a designated area. In this example, the 3D facility data 20 contains 3D segment data 22-1 to 22-5. FIG. 6A shows a projection of the 3D facility data 20 displayed in the display area 14. A designated area 16 represents a designated area designated by the user 40.

FIGS. 6B and 6C show the 3D facility data 20 in a plan view and in a side view, respectively. In each of these drawings, the 3D segment data 22 determined as the designated segment is filled with diagonal lines. An extended area 18 is an area obtained by extending the designated area 16 in the depth direction.

Note that all the 3D segment data 22-1, 22-2 and 22-3 entirely overlap the extended area 18 (i.e., they are entirely contained in the extended area 18). Meanwhile, each of the 3D segment data 22-4 and 22-5 does not entirely overlap the extended area 18, but only a part thereof overlaps the extended area 18.

In FIGS. 6A to 6C, the segment determining unit 2040 determines only the 3D segment data 22 each of which entirely overlaps the extended area 18 as the 3D segment data 22 of the designated segment. Therefore, the 3D segment data 22-1, 22-2 and 22-3 are determined as the 3D segment data 22 of the designated segment. Meanwhile, neither the 3D segment data 22-4 nor 22-5 is determined as the 3D segment data 22 of the designated segment.

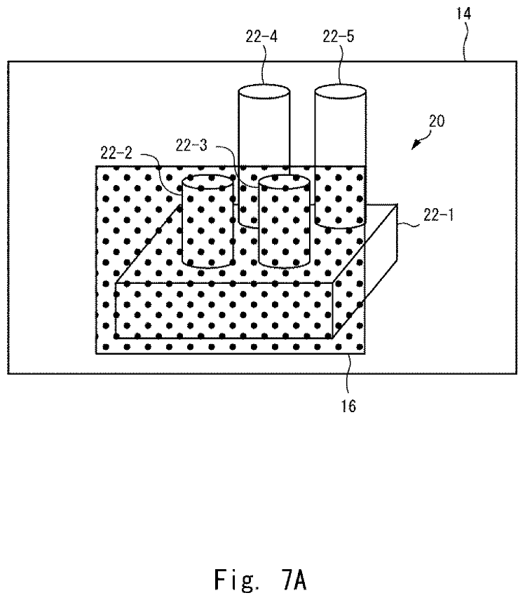

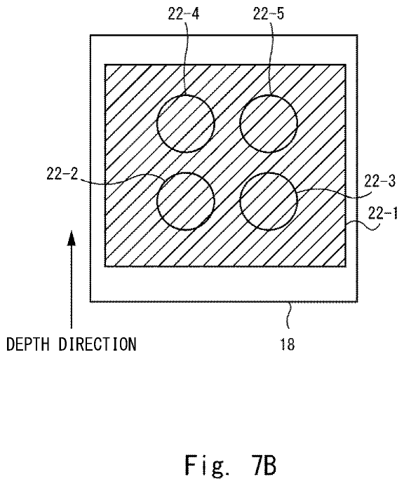

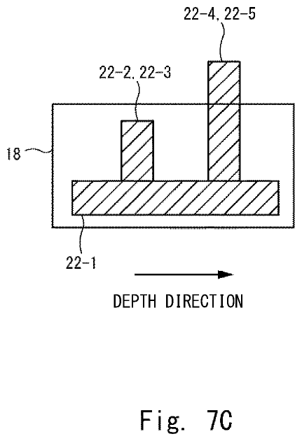

The segment determining unit 2040 may determine 3D segment data 22 at least a part of which overlaps the extended area 18 as the 3D segment data 22 of the designated segment. FIGS. 7A to 7C are second diagrams showing an example of a method for determining a designated segment based on a designated area. In the example shown in FIGS. 7A to 7C, the contents displayed in the display area 14 and the designated area 16 are the same as those in the example shown in FIGS. 6A to 6C. Therefore, the contents shown in FIG. 7A is the same as those shown in FIG. 6A.

However, in the example shown in FIGS. 7A to 7C, 3D segment data 22 at least a part of which overlaps the extended area 18 is determined as the 3D segment data 22 of the designated segment. Therefore, in FIGS. 7B and 7C, in addition to the 3D segment data 22-1 to 22-3, the 3D segment data 22-4 and 22-5 are also determined as the 3D segment data 22 of the designated segment.

Note that the segment determining unit 2040 may determine a candidate(s) for a designated segment (hereinafter also referred to simply as a candidate segment(s)), instead of determining a designated segment according to the above-described method. For example, in the example shown in FIGS. 7A to 7C, the 3D segment data 22-1 to 22-3 are handled as 3D segment data 22 of candidate segments.

The segment determining unit 2040 receives, from the user 40, an input for confirming whether the segment is successfully designated as he/she intends. To do so, in response to the input by the user for designating a designated point or a designated area, the segment determining unit 2040 changes the image or the like displayed on the input screen 10 based on the input by the user so that the user 40 can recognize the determined candidate segment. For example, the segment determining unit 2040 changes the color of the 3D segment data 22 of the candidate segment so that the user 40 can recognize the candidate segment.

For example, the user 40 performs an input operation to finalize the designation of the segment. For example, this input operation is an operation of pressing a specific button (such as a decision button) displayed on the input screen 10. In response to this input operation, the segment determining unit 2040 determines the candidate segment as the designated segment. By handling the segment determined based on the designation by the user 40 as the candidate segment and then requesting the user 40 to input the confirmation as described above, it is possible to enable the user 40 to confirm whether there is a mistake in his/her designation.

Note that the input screen 10 may receive an input for changing the candidate segment. For example, a 3D area, such as a cuboid in which the candidate segment is contained, is displayed on the input screen 10. The user 40 changes the candidate segment by changing the shape of this 3D area so as to contain only the 3D segment data 22 of the segment that he/she wants to handle as the designated segment.

### <Determination of Designated Area: S106>

The area determining unit 2060 determines a designated area based on the designated segment data, which is the 3D segment data 22 of the designated segment determined by the segment determining unit 2040 (S106). The area determining unit 2060 may determine the 3D area represented by the designated segment data as it is as the designated area, or may determine another 3D area that is obtained based on the 3D area represented by the designated segment data as the designated area.

For example, the area determining unit 2060 computes a 3D area having a predetermined shape (e.g., a spherical shape) that is centered at a reference point of the designated segment data (e.g., the center of mass of the designated segment data) and that contains the designated segment data, and determines this computed 3D area as the designated area. This 3D area may be the smallest area that contains the designated segment data, or may be an area that is obtained by enlarging this smallest area by a predetermined factor.

Alternatively, for example, the area determining unit 2060 determines, as the designated area, a 3D area that is obtained by enlarging the designated segment data by a specific method. For example, the area determining unit 2060 determines, as the designated area, a 3D area that is obtained by enlarging the designated segment data by a predetermined factor while using the reference point of the designated segment data as the center of the enlargement. Alternatively, for example, the area determining unit 2060 determines, as the designated area, a 3D area representing a range extending from the designated segment data to points separated therefrom by a specific distance (hereinafter also referred to as a margin). This 3D area can also be expressed as “an area that is obtained by adding a margin to the designated segment data in each direction”.

The margin has, for example, a fixed value irrespective of the facility. In this case, the value of the margin is stored in advance in a storage device accessible from the area determination apparatus 2000.

Alternatively, for example, the margin may have a different value for each facility. In this case, a plurality of values for the margin are stored, in a storage device accessible from the area determination apparatus 2000, in association with identification information of respective facilities. The area determining unit 2060 acquires, from the storage device, the value for the margin corresponding to the identification information of the target facility designated by the user 40, and uses the acquired value as the margin.

Alternatively, for example, the margin may have a different value for each attribute of the facility. The attribute of the facility may be, for example, the type of the facility, characteristics of what are handled in the facility (such as the magnitude of a voltage in a power plant or the degree of risk of chemicals used in a chemical plant), or the like. In this case, a plurality of values for the margin are stored, in a storage device accessible from the area determination apparatus 2000, in association with respective attributes of the facility. Further, a plurality of attributes of facilities are stored, in a storage device accessible from the area determination apparatus 2000, in association with identification information of respective facilities. The area determining unit 2060 acquires the attribute of the target facility using the identification information of the target facility designated by the user 40. Further, the area determining unit 2060 acquires the value of the margin corresponding to the determined attribute of the facility.

Note that a plurality of attributes may be associated with one facility. In this case, for example, the area determining unit 2060 acquires values of the margins associated with respective attributes of the target facility and determines the designated area using the largest value of the margin.

Alternatively, for example, the margin may have a different value for each segment. In this case, for example, a plurality of values for the margin corresponding to respective segments included in a facility are stored, in a storage device accessible from the area determination apparatus 2000, in association with the identification information of the facility. The area determining unit 2060 acquires the value of the margin corresponding to the designated segment data from the aforementioned storage device.

Alternatively, for example, the margin may have a different value for each attribute of the segment. In this case, a plurality of values for the margins are stored, in a storage device accessible from the area determination apparatus 2000, in association with respective attributes of the segment. The attribute of the segment may be, for example, the type of the segment, characteristics of what are handled in the segment (such as the magnitude of a voltage or the degree of risk of chemicals), or the like. For example, in the case of a power plant, information indicating the value of the margin, such as “Margin=1 m”, is associated with an attribute such as “Segment type: Lead wire, Characteristic: Voltage=2,200 V”. Further, in this case, a plurality of pieces of information indicating attributes of respective segments included in facilities are stored, in a storage device accessible from the area determination apparatus 2000, in association with identification information of respective facilities. The area determining unit 2060 acquires information indicating the attribute of the designated segment using the identification information of the target facility and the identification information of the designated segment. Further, the area determining unit 2060 acquires the value of the margin corresponding to the attribute of the designated segment.

As described above, according to the method for determining a designated area by adding a margin around 3D segment data 22 of a designated segment, it is possible to automatically include not only a 3D area represented by the designated segment but also a predetermined area around the 3D area in the designated area. Therefore, it is possible to easily perform monitoring such as “issuing a warning when a person to be monitored or the like enters a predetermined area around a designated segment”.

For example, in a certain facility such as a power plant, there may be a guide line or a regulation that specifies how much distance should be kept from equipment according to the attribute of the equipment. Therefore, for each segment, the value of the margin is determined in association with the attribute of that segment based on the guideline or the like as described above. In this way, it is possible easily set a monitoring area for operating a facility in accordance with the guideline or the like

<<Which of Monitoring Area and Non-Monitoring Area should be Handled>>

Which of a monitoring area and a non-monitoring area should be handled as the designated area may be determined in advance in a fixed manner or may be selected by the user 40. In the latter case, for example, in the input screen 10, the user 40 is allowed to select which of a monitoring area or a non-monitoring area he/she wants to designate as the designated area. For example, the user 40 may first select which of a monitoring area or a non-monitoring area is designated as the designated area through an input interface such as a radio button, and then input a designated point or the like. By doing so, he/she can select which of a monitoring area or a non-monitoring area he/she intends to set as the designated area by the designated point or the like when the user 40 inputs a designated point or the like.

Alternatively, for example, it may be configured to display an input interface (e.g., a pop-up window) for selecting a monitoring area or a non-monitoring area in response to the user 40 inputting a designated point or the like. The user 40 uses that input interface to select which of a monitoring area or a non-monitoring area he/she wants to designate as the designated area.

### <Output by Area Determination Apparatus 2000>

The area determination apparatus 2000 outputs information indicating the designated area determined by the area determining unit 2060. Hereafter, this information is referred to as area information. Further, the functional component that outputs area information is referred to as an outputting unit (not illustrated). The area information includes, for example, identification information of the target facility, 3D data representing the designated area, and a label indicating whether the designated area is a monitoring area or a non-monitoring area. Note that when a plurality of segments is designated by the user 40, area information includes information about a plurality of designated areas determined for respective designated segments. Alternatively, for example, when the designated area is a non-monitoring area, the outputting unit may compute a monitoring area obtained by excluding the non-monitoring area from the specific space and output area information indicating the computed monitoring area. In this case, the area information does not have to contain the above-described label.

The area information can be output in various manners. For example, the area determination apparatus 2000 puts the area information in an arbitrary storage device. Alternatively, for example, the area determination apparatus 2000 displays the area information on a display device the user 40 can see. Alternatively, for example, the area determination apparatus 2000 may output the area information to another apparatuses. For example, this “another apparatus” is a monitoring apparatus 3000 described later.

### <Example of Use of Area Determination Apparatus 2000>

To facilitate the understanding of the area determination apparatus 2000, an example of a situation in which the area determination apparatus 2000 is used is shown below. The following description is merely an example, and the situations in which the area determination apparatus 2000 is used are not limited to the following example.

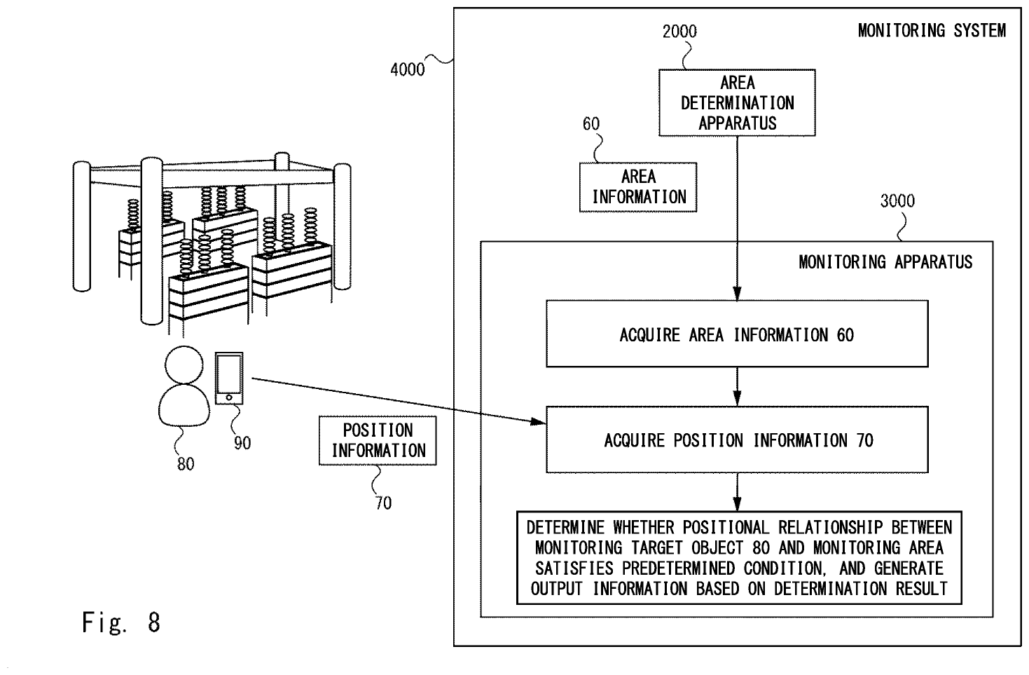

FIG. 8 shows an example of a monitoring system 4000. The monitoring system 4000 includes an area determination apparatus 2000 and a monitoring apparatus 3000. In the monitoring system 4000, a monitoring area determined using the area determination apparatus 2000 is used in monitoring performed by the monitoring apparatus 3000. Note that when a non-monitoring area is determined in the area determination apparatus 2000, a space that is obtained by excluding the non-monitoring area from the space including the facility to be monitored and the area therearound is handled as a monitoring area.

The monitoring apparatus 3000 acquires area information 60 generated by the area determination apparatus 2000. Further, the monitoring apparatus 3000 acquires position information 70 indicating the position of a monitoring target object 80 from a sensor 90. The monitoring target object is any object: e.g., a person working in the target facility or a moving object such as a drone monitoring the state of the target facility. The sensor 90 is any sensor capable of measuring a location thereof, such as a GPS sensor. For example, the sensor 90 may be carried by the monitoring target object 80 or attached to the monitoring target object 80. The position of the monitoring target object 80 is represented by coordinates on a predetermined coordinate system in which a position in the real world can be indicated. For example, in the case where the sensor 90 is a GPS sensor, the position of the monitoring target object 80 is represented by GPS coordinates.

The monitoring apparatus 3000 determines whether or not the positional relationship between the monitoring target object 80 and the monitoring area satisfies a predetermined condition, and generates output information based on the result of the determination. For example, the predetermined condition is that “the monitoring target object 80 is within the monitoring area”. In this case, for example, when the predetermined condition is satisfied, the monitoring apparatus 3000 outputs, as the output information, warning information indicating a predetermined warning.

Note that the coordinate system used to indicate the monitoring area (hereinafter also referred to as a first coordinate system) and the coordinate system used to indicate the position of the monitoring target object 80 (hereinafter also referred to as a second coordinate system) may be the same as each other or different from each other. In the latter case, for example, the monitoring apparatus 3000 unifies the coordinate system indicating the monitoring target object 80 and that indicating the monitoring area in order to determine the positional relationship between the monitoring target object 80 and the monitoring area. For example, the monitoring apparatus 3000 converts the position of the monitoring target object 80 into coordinates in the first coordinate system, and then determines whether or not the position of the monitoring target object 80 is included in the monitoring area. Alternatively, for example, the monitoring apparatus 3000 may convert the monitoring area into an area in the second coordinate system, and then determine whether or not the position of the monitoring target object is included in the monitoring area.

Note that the unification of the coordinate systems may be carried out by the area determination apparatus 2000. In this case, the area determination apparatus 2000 converts the coordinate data representing the designated area determined by the area determining unit 2060 into coordinate data in the second coordinate system, and outputs area information 60 in which the designated area is indicated by the converted coordinate data.

### <<Example of Functional Configuration of Monitoring Apparatus 3000>>

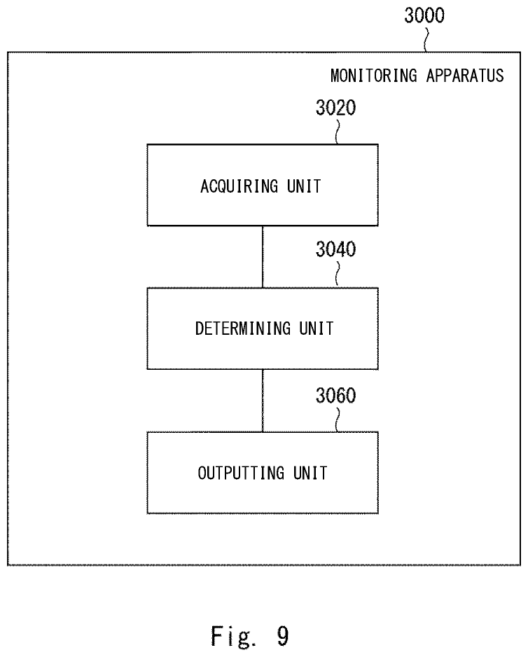

FIG. 9 shows an example of a functional configuration of the monitoring apparatus 3000. The monitoring apparatus 3000 includes an acquiring unit 3020, a determining unit 3040, and an outputting unit 3060. The acquiring unit 3020 acquires area information 60 and position information 70. The determining unit 3040 determines whether or not the positional relationship between the monitoring target object 80 and the monitoring area satisfies a predetermined condition. The outputting unit 3060 outputs output information based on the result of this determination.

### <<Example of Hardware Configuration of Monitoring Apparatus 3000>>

Similarly to the hardware configuration of the area determination apparatus 2000, the hardware configuration of the monitoring apparatus 3000 may be, for example, one shown in FIG. 3. However, programs for implementing respective functions of the monitoring apparatus 3000 are stored in the storage device of the computer that implements the monitoring apparatus 3000.

<<Flow of Processes performed by Monitoring Apparatus 3000>>

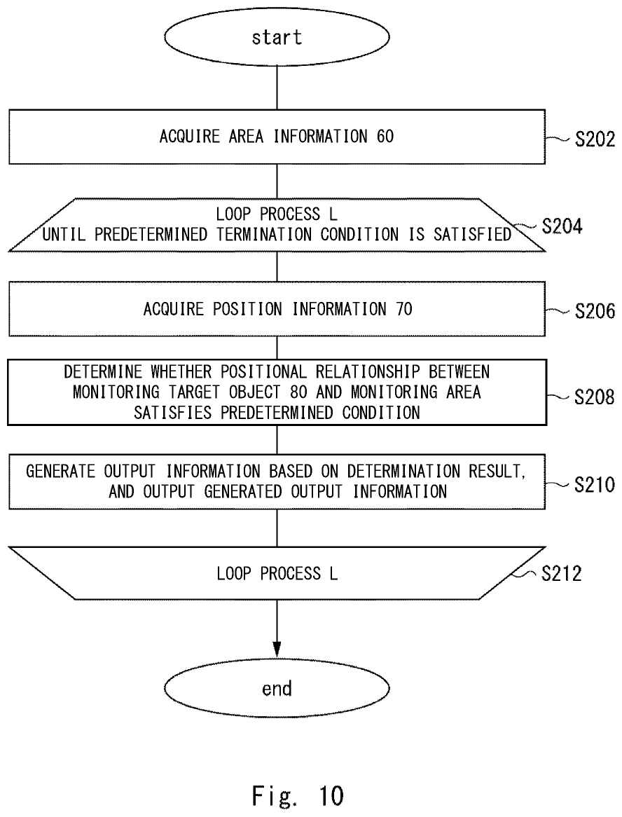

FIG. 10 is a flowchart showing an example of a flow of processes performed by the monitoring apparatus 3000. The acquiring unit 3020 acquires area information 60 (S202). Steps S204 to S212 constitute a loop process L which is repeatedly performed until a predetermined termination condition is satisfied. In the step S204, the monitoring apparatus 3000 determines whether or not the termination condition is satisfied. When the termination condition is satisfied, the series of processes shown in FIG. 10 ends. On the other hand, when the termination condition is not satisfied, the process in FIG. 10 proceeds to the step S206.

The acquiring unit 3020 acquires position information 70 (S206). The determining unit 3040 determines whether or not the positional relationship between the monitoring target object 80 and the monitoring area satisfies a predetermined condition by using the area information 60 and the position information 70 (S208). The outputting unit 3060 generates output information based on the result of this determination and outputs the generated output information (S210). Since the step S212 is the end of the loop process L, the process in FIG. 10 returns to the step S204.

An arbitrary termination condition can be used as the termination condition of the loop process L. For example, the termination condition may be a condition such as “An input indicating the termination of the monitoring is entered by the user” or “Position information 70 has not been transmitted from the sensor 90 for a predetermined time or longer”.

Note that the flow of processes performed by the monitoring apparatus 3000 is not limited to that shown in FIG. 10. For example, the output information may not be generated and output at all times. For example, when the monitoring target object 80 is within the monitoring area, output information representing a warning may be output, whereas when the monitoring target object 80 is not within the monitoring area, no output information may be output.

Further, the monitoring process represented by the loop process L does not need to be started immediately after the acquisition of the area information 60. For example, the loop process L may be started when a predetermined start condition is satisfied. The start condition is, for example, a condition such as “An input indicating the start of monitoring has been entered by the user” or “Position information 70 has been received from the sensor 90”.

### <<Acquisition of Area Information 60: S202>

The acquiring unit 3020 acquires area information 60 generated by the area determination apparatus 2000 (S202). There are various methods by which the acquiring unit 3020 acquires area information 60. Suppose that area information 60 has been stored in a storage device accessible from the monitoring apparatus 3000 by the area determination apparatus 2000. In this case, the acquiring unit 3020 acquires area information 60 from this storage device. Alternatively, for example, the acquiring unit 3020 may acquire area information 60 by receiving area information 60 that has been transmitted from the area determination apparatus 2000 to the monitoring apparatus 3000.

Note that when there is a plurality of facilities that can be handled as those to be monitored, the monitoring apparatus 3000 acquires area information 60 corresponding to the facility to be monitored. In this case, for example, the monitoring apparatus 3000 receives an input for selecting the facility to be monitored from the user. The monitoring apparatus 3000 acquires area information 60 indicating the identification information of the selected facility.

### <<Acquisition of Position Information 70: S206>

The acquiring unit 3020 acquires position information 70 from the sensor 90 (S206). There are various methods by which the acquiring unit 3020 acquires position information 70. Suppose that position information 70 is stored in a storage device accessible from the monitoring apparatus 3000 by the sensor 90. In this case, for example, the acquiring unit 3020 periodically accesses this storage device and, when position information 70 that the acquiring unit 3020 has not acquired yet is stored therein, acquires this position information 70. Alternatively, for example, the acquiring unit 3020 may acquire position information 70 by receiving position information 70 that has been transmitted from the sensor 90 to the monitoring apparatus 3000.

<<Determination on Positional Relationship between Monitoring target object 80 and Monitoring Area: S208>>

The determining unit 3040 determines whether or not the positional relationship between the monitoring target object 80 and the monitoring area satisfies a predetermined condition by using the area information 60 and the position information 70 (S208). The predetermined condition is, for example, “the monitoring target object 80 is within the monitoring area”. That is, in this case, the determining unit 3040 determines whether or not the monitoring target object 80 is within the monitoring area.

Alternatively, for example, the predetermined condition is “the distance between the monitoring target object 80 and the monitoring area is equal to or shorter than a threshold T (T>0)”. In this case, it is possible to determine whether or not the monitoring target object 80 has reached an area that is the threshold T or less away from the monitoring area. For example, the outputting unit 3060 outputs warning information when the distance from the monitoring area is equal to or shorter than the threshold T.

A plurality of conditions may be used as the predetermined condition. Suppose that a first condition “the monitoring target object 80 is within the monitoring area” and a second condition “the distance between the monitoring target object 80 and the monitoring area is less than or equal to the threshold T and larger than zero (T>0)” are set. In this case, for example, the outputting unit 3060 performs: 1) outputting warning information indicating a first-level warning when the first condition is satisfied; 2) outputting warning information indicating a second-level warning when the second condition is satisfied; and 3) outputting no warning information when neither of the conditions is satisfied. In this case, the strengths of the warnings are expressed as “First level>Second level”. In this way, it is possible to issue a warning of a desired level according to the distance between the monitoring target object 80 and the monitoring area.

Further, a plurality of thresholds having different levels may be set. Assume that, for example, a first condition “the monitoring target object 80 is within the monitoring area”, a second condition “the distance between the monitoring target object 80 and the monitoring area is less than or equal to the threshold T1 and larger than zero (T>0), and a third condition “the distance between the monitoring target object 80 and the monitoring area is less than equal to the threshold T2 and larger than T1 (T2>T1)” are set. In this case, for example, the outputting unit 3060 performs: 1) outputting warning information indicating a first-level warning when the first condition is satisfied; 2) outputting warning information indicating a second-level warning when the second condition is satisfied; 3) outputting warning information indicating a third-level warning when the third condition is satisfied; and 3) outputting no warning information when none of the conditions is satisfied. In this case, the strengths of the warnings are expressed as “First level>Second level>Third level”. By setting a plurality of thresholds as described above, it is possible to adjust the strength of the warning according to the position of the monitoring target object 80 in a more detailed manner.

### <<Generation and Output of Output Information: S210>>

The outputting unit 3060 generates output information based on the result of the determination by the determining unit 3040 and outputs the generated output information (S210). For example, the determining unit 3040 outputs warning information according to the result of the determination as described above. Various types of warning information can be used. For example, warning information indicates a message to the monitoring target object 80. For example, when the monitoring target object 80 is within the monitoring area, a message such as “You are in a dangerous area” or “Stay away from XXX” can be used. Note that “XXX” is, for example, the name of the segment corresponding to the monitoring area. Further, in the case where the distance from the monitoring area is equal to or smaller than the threshold, a message such as “Be careful, you are within Y m from XXX” can be used. Note that as the value of Y, the distance from the monitoring target object 80 to the monitoring area computed using the position information of the monitoring target object 80 is used.

When the monitoring target object 80 is a person, the warning information is output to, for example, a terminal carried by that person. Further, when the monitoring target object 80 is a moving object such as a drone, the warning information is output to, for example, a terminal used by a person who is operating the moving object.

The warning information may be information other than messages. For example, the warning information may be expressed by the color of the screen of the terminal. For example, the output of warning information of the first level may be expressed by turning into red the color of the screen of the terminal to which the warning information is output, while the output of warning information of the second level may be expressed by turning into yellow the color of the screen of the terminal to which the warning information is output.

Further, the warning information may be expressed by a sound or a voice (such as a voice message or a beep sound). This sound or voice is, for example, played back from a speaker of the terminal to which the warning information is output.

The output information is not limited to information indicating a warning. For example, the outputting unit 3060 may output information indicating the result of the determination by the determining unit 3040 (in other words, information by which it is possible to know whether or not the predetermined condition has been satisfied). Suppose the predetermined condition is “the monitoring target object 80 is within the monitoring area”. In this case, for example, information by which it is possible to know whether the monitoring target object 80 is inside the monitoring area or outside thereof is output as the output information. Specifically, when the monitoring target object 80 is outside the monitoring area, output information indicating a message such as “You are outside the monitoring area” is output. On the other hand, when the monitoring target object 80 is inside the monitoring area, output information indicating a message such as “You are in the monitoring area” is output.

Note that similarly to the warning information, the information indicating the result of the determination may be expressed by the color of the screen of the terminal, a sound or a voice, or the like instead of the message.

Although the present invention is described above with reference to example embodiments, the present invention is not limited to the above-described example embodiments. Various modifications that can be understood by those skilled in the art can be made to the configuration and details of the present invention within the scope and spirit of the invention.

Note that, in the above-described examples, the program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM, CD-R, CD-R/W, and semiconductor memories (such as mask ROM, PROM (Programmable ROM), EPROM (Erasable PROM), flash ROM, RAM, etc.). Further, the program may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

The whole or part of the example embodiments disclosed above can be described as, but not limited to, the following supplementary notes.

(Supplementary Note 1)

An area determination apparatus comprising:
an acquiring unit configured to acquire three-dimensional facility data, which is three-dimensional data of a target facility including a plurality of segments;
a segment determining unit configured to determine a designated segment, which is a segment designated in an input screen including an image of the target facility; and
an area determining unit configured to determine, as a monitoring area or a non-monitoring area, a three-dimensional area that is determined based on three-dimensional data of the designated segment.

(Supplementary Note 2)

The area determination apparatus according to Supplementary note 1,

wherein the segment determining unit determines the segment contained in the area that is designated in the input screen as the designated segment, or determines the segment at least a part of which overlaps the area that is designated in the input screen as the designated segment.

(Supplementary Note 3)

The area determination apparatus according to Supplementary note 1 or 2,
wherein the area determining unit determines a three-dimensional area obtained by adding a margin around the designated segment as the monitoring area or the non-monitoring area.

(Supplementary Note 4)

The area determination apparatus according to Supplementary note 3,
wherein information indicating an association between an attribute of the segment and a value of the margin is stored in a storage device, and
wherein the area determining unit acquires a value of the margin corresponding to the attribute of the designated segment from the storage device, and determines a three-dimensional area obtained by adding the margin of the acquired value around the designated segment as the monitoring area or the non-monitoring area.

(Supplementary Note 5)

The area determination apparatus according to any one of Supplementary notes 1 to 4, further comprising an outputting unit configured to output area information indicating the determined monitoring area or non-monitoring area.

(Supplementary Note 6)

A control method performed by a computer, comprising:
an acquisition step of acquiring three-dimensional facility data, which is three-dimensional data of a target facility including a plurality of segments;
a segment determining step of determining a designated segment, which is a segment designated in an input screen including an image of the target facility; and
an area determination step of determining, as a monitoring area or a non-monitoring area, a three-dimensional area that is determined based on three-dimensional data of the designated segment.

(Supplementary Note 7)

The control method according to Supplementary note 6,
wherein in the segment determining step, the segment contained in the area that is designated in the input screen is determined as the designated segment, or the segment at least a part of which overlaps the area that is designated in the input screen is determined as the designated segment.

(Supplementary Note 8)

The control method according to Supplementary note 6 or 7,
wherein in the area determination step, a three-dimensional area obtained by adding a margin around the designated segment is determined as the monitoring area or the non-monitoring area.

(Supplementary Note 9)

The control method according to Supplementary note 8,
wherein information indicating an association between an attribute of the segment and a value of the margin is stored in a storage device, and
wherein, in the area determination step, a value of the margin corresponding to the attribute of the designated segment is acquired from the storage device, and a three-dimensional area obtained by adding the margin of the acquired value around the designated segment is determined as the monitoring area or the non-monitoring area.

(Supplementary Note 10)

The control method according to any one of Supplementary notes 6 to 9, further comprising an output step of outputting area information indicating the determined monitoring area or non-monitoring area.

(Supplementary Note 11)

A computer readable medium storing a program for causing a computer to perform:
an acquisition process for acquiring three-dimensional facility data, which is three-dimensional data of a target facility including a plurality of segments;
a segment determining process for determining a designated segment, which is a segment designated in an input screen including an image of the target facility; and
an area determination process for determining, as a monitoring area or a non-monitoring area, a three-dimensional area that is determined based on three-dimensional data of the designated segment.

(Supplementary Note 12)

The computer readable medium according to Supplementary note 11,
wherein in the segment determining process, the segment contained in the area that is designated in the input screen is determined as the designated segment, or the segment at least a part of which overlaps the area that is designated in the input screen is determined as the designated segment.

(Supplementary Note 13)

The computer readable medium according to Supplementary note 11 or 12,
wherein in the area determination process, a three-dimensional area obtained by adding a margin around the designated segment is determined as the monitoring area or the non-monitoring area.

(Supplementary Note 14)

The computer readable medium according to Supplementary note 13,
wherein information indicating an association between an attribute of the segment and a value of the margin is stored in a storage device, and
wherein, in the area determination process, a value of the margin corresponding to the attribute of the designated segment is acquired from the storage device, and a three-dimensional area obtained by adding the margin of the acquired value around the designated segment is determined as the monitoring area or the non-monitoring area.

(Supplementary Note 15)

The computer readable medium according to any one of Supplementary notes 11 to 14, further comprising an output process of outputting area information indicating the determined monitoring area or non-monitoring area.

(Supplementary Note 16)

A monitoring system comprising an area determination apparatus and a monitoring apparatus,
wherein the area determination apparatus comprises:
an acquiring unit configured to acquire three-dimensional facility data, which is three-dimensional data of a target facility including a plurality of segments;
a segment determining unit configured to determine a designated segment, which is the segment designated in an input screen including an image of the target facility;
an area determining unit configured to determine, as a monitoring area or a non-monitoring area, a three-dimensional area that is determined based on three-dimensional data of the designated segment; and
an outputting unit configured to output area information indicating the monitoring area or the non-monitoring area, and
wherein the monitoring apparatus comprises:
an acquiring unit configured to acquire the area information and position information indicating a position of a monitoring target object;
a determining unit configured to determine whether or not a positional relationship between the position of the monitoring target object and the monitoring area that is determined based on the area information satisfies a predetermined condition; and
an outputting unit configured to output output information based on a result of the determination.

(Supplementary Note 17)

A monitoring method performed by a monitoring system comprising an area determination apparatus and a monitoring apparatus, comprising:
an acquisition step of, by the area determination apparatus, acquiring three-dimensional facility data, which is three-dimensional data of a target facility including a plurality of segments;
a segment determining step of, by the area determination apparatus, determining a designated segment, which is the segment designated in an input screen including an image of the target facility;
an area determination step of, by the area determination apparatus, determining, as a monitoring area or a non-monitoring area, a three-dimensional area that is determined based on three-dimensional data of the designated segment; and
an output step of, by the area determination apparatus, outputting area information indicating the monitoring area or the non-monitoring area, and
an acquisition step of, by the monitoring apparatus, acquiring the area information and position information indicating a position of a monitoring target object;
a determination step of, by the monitoring apparatus, determining whether or not a positional relationship between the position of the monitoring target object and the monitoring area that is determined based on the area information satisfies a predetermined condition; and
an output step of, by the monitoring apparatus, outputting output information based on a result of the determination.

### REFERENCE SIGNS LIST

10 INPUT SCREEN
14 DISPLAY AREA
16 DESIGNATED AREA
18 EXTENDED AREA
20 3D FACILITY DATA
22 3D SEGMENT DATA
40 USER
60 AREA INFORMATION
70 POSITION INFORMATION
80 MONITORING TARGET OBJECT
90 SENSOR
500 COMPUTER
502 BUS
504 PROCESSOR
506 MEMORY
508 STORAGE DEVICE
510 INPUT/OUTPUT INTERFACE
512 NETWORK INTERFACE
2000 AREA DETERMINATION APPARATUS
2020 ACQUIRING UNIT
2040 SEGMENT DETERMINING UNIT
2060 AREA DETERMINING UNIT
3000 MONITORING APPARATUS
3020 ACQUIRING UNIT
3040 DETERMINING UNIT
3060 OUTPUTTING UNIT
4000 MONITORING SYSTEM

What is claimed is:

1. An area determination apparatus comprising:
at least one memory that is configured to store instructions; and
at least one processor that is configured to execute the instructions to:
acquire three-dimensional facility data, which is three-dimensional data of a target facility including a plurality of segments;
determine a designated segment, which is a segment designated in an input screen including an image of the target facility; and
determine, as a monitoring area or a non-monitoring area, a three-dimensional area that is determined based on three-dimensional data of the designated segment.

2. The area determination apparatus according to claim 1,
wherein the at least one processor is configured to execute the instructions further to:
determine the segment contained in the area that is designated in the input screen as the designated segment; or
determine the segment at least a part of which overlaps the area that is designated in the input screen as the designated segment.

3. The area determination apparatus according to claim 1,
wherein the at least one processor is configured to execute the instructions further to: determine a three-dimensional area obtained by adding a margin around the designated segment as the monitoring area or the non-monitoring area.

4. The area determination apparatus according to claim 3,
wherein information indicating an association between an attribute of the segment and a value of the margin is stored in a storage device, and
wherein the at least one processor is configured to execute the instructions further to:
acquire a value of the margin corresponding to the attribute of the designated segment from the storage device; and
determine a three-dimensional area obtained by adding the margin of the acquired value around the designated segment as the monitoring area or the non-monitoring area.

5. The area determination apparatus according to claim 1,
wherein the at least one processor is configured to execute the instructions further to: output area information indicating the determined monitoring area or non-monitoring area.

6. A control method performed by a computer, comprising:
acquiring three-dimensional facility data, which is three-dimensional data of a target facility including a plurality of segments;
determining a designated segment, which is a segment designated in an input screen including an image of the target facility; and
determining, as a monitoring area or a non-monitoring area, a three-dimensional area that is determined based on three-dimensional data of the designated segment.

7. The control method according to claim 6, further comprising:
determining the segment contained in the area that is designated in the input screen as the designated segment; or
determining the segment at least a part of which overlaps the area that is designated in the input screen as the designated segment.

8. The control method according to claim 6, further comprising:
determining a three-dimensional area obtained by adding a margin around the designated segment as the monitoring area or the non-monitoring area.

9. The control method according to claim 8,
wherein information indicating an association between an attribute of the segment and a value of the margin is stored in a storage device, and
wherein the control method further comprises:
acquiring a value of the margin corresponding to the attribute of the designated segment from the storage device; and
determining a three-dimensional area obtained by adding the margin of the acquired value around the designated segment as the monitoring area or the non-monitoring area.

10. The control method according to claim 6, further comprising: outputting area information indicating the determined monitoring area or non-monitoring area.

11. A non-transitory computer readable medium storing a program for causing a computer to perform:
acquiring three-dimensional facility data, which is three-dimensional data of a target facility including a plurality of segments;
determining a designated segment, which is a segment designated in an input screen including an image of the target facility; and
determining, as a monitoring area or a non-monitoring area, a three-dimensional area that is determined based on three-dimensional data of the designated segment.

12. The computer readable medium according to claim 11,
wherein the program further causes the computer to perform:
determining the segment contained in the area that is designated in the input screen as the designated segment; or
determining the segment at least a part of which overlaps the area that is designated in the input screen as the designated segment.

13. The computer readable medium according to claim 11,
wherein the program causes the computer to further perform: determining a three-dimensional area obtained by adding a margin around the designated segment as the monitoring area or the non-monitoring area.

14. The computer readable medium according to claim 13,
wherein information indicating an association between an attribute of the segment and a value of the margin is stored in a storage device, and
wherein the program causes the computer to further perform:
acquiring a value of the margin corresponding to the attribute of the designated segment from the storage device; and
determining a three-dimensional area obtained by adding the margin of the acquired value around the designated segment as the monitoring area or the non-monitoring area.

15. The computer readable medium according to claim 11,
wherein the program causes the computer to further perform: outputting area information indicating the determined monitoring area or non-monitoring area.

16. A monitoring system comprising an area determination apparatus and a monitoring apparatus,
wherein the area determination apparatus comprises:
at least one memory that is configured to store instructions; and
at least one processor that is configured to execute the instructions to:
acquire three-dimensional facility data, which is three-dimensional data of a target facility including a plurality of segments;
determine a designated segment, which is the segment designated in an input screen including an image of the target facility;
determine, as a monitoring area or a non-monitoring area, a three-dimensional area that is determined based on three-dimensional data of the designated segment; and
output area information indicating the monitoring area or the non-monitoring area, and
wherein the monitoring apparatus comprises:
at least one memory that is configured to store instructions; and
at least one processor that is configured to execute the instructions to:
acquire the area information and position information indicating a position of a monitoring target object;
determine whether or not a positional relationship between the position of the monitoring target object and the monitoring area that is determined based on the area information satisfies a predetermined condition; and
output information regarding a result of the determination.

17. A monitoring method performed by a monitoring system comprising an area determination apparatus and a monitoring apparatus, comprising:
the area determination apparatus acquires three-dimensional facility data, which is three-dimensional data of a target facility including a plurality of segments;
the area determination apparatus, determining a designated segment, which is the segment designated in an input screen including an image of the target facility;
the area determination apparatus determines, as a monitoring area or a non-monitoring area, a three-dimensional area that is determined based on three-dimensional data of the designated segment; and
the area determination apparatus outputs area information indicating the monitoring area or the non-monitoring area, and
the monitoring apparatus acquires the area information and position information indicating a position of a monitoring target object;
the monitoring apparatus determines whether or not a positional relationship between the position of the monitoring target object and the monitoring area that is determined based on the area information satisfies a predetermined condition; and
the monitoring apparatus outputs information regarding a result of the determination.
